(19) United States
(12) Patent Application Publication
(10) Pub. No.: US 2007/0210467 A1
(43) Pub. Date: Sep. 13, 2007

(54) APPARATUS FOR FABRICATING COVER LAYER OF OPTICAL INFORMATION STORAGE MEDIA AND OPERATING METHOD OF THE SAME

(76) Inventors: Wen-Yih Liao, Taichung City (TW); Ching-Yu Hsieh, Hsinchu County (TW); Ying-Tsai Chen, Taoyuan County (TW); Hung- Chang Chen, Taoyuan County (TW); Chao- Ching Lin, Taoyuan County (TW); Fu-Hsi Yu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,274

(22) Filed: Mar. 15, 2006

(30) Foreign Application Priority Data
Mar. 8, 2006 (TW) 95107719

(51) Int. Cl. B29D 11/00; B29D 17/00; B29C 43/08; B29C 35/08

(52) U.S. Cl. 264/1.33; 425/174.4; 425/810; 264/1.38; 264/1.7

(57) ABSTRACT

An apparatus for fabricating a coverlayer of optical information storage media is disclosed. The apparatus comprises a rotating platform, a rotating plate and a UV irradiation system. A substrate is disposed on the rotating platform and a radiation setting resin material is disposed on a surface of the substrate. The rotating plate is moved towards the rotating platform to compress the radiation-setting resin material against the substrate. The resulting structure is rotated by rotating the rotating platform. A thin radiation-setting resin layer with a uniform thickness is formed on the substrate. The radiation-setting resin layer is illuminated by a UV light to harden the radiation-setting resin layer. Next, the rotating plate is separated from the radiation-setting resin layer while the radiation-setting resin layer remains adhered to the substrate. The hardened radiation-setting resin layer serves as a coverlayer of the optical information storage media.

### CROSS-REFERENCE TO RELATED APPLICATION

This application claims the priority benefit of Taiwan application serial no. 95107719, filed on March 8, 2006. All disclosure of the Taiwan application is incorporated herein by reference.

### BACKGROUND OF THE INVENTION

1. Field of the Invention

The present invention generally relates to an apparatus for fabricating a coverlayer. More particularly, the present invention relates to an apparatus for fabricating a coverlayer of an optical information storage media, and an operating method of the same.

2. Description of Related Art

A digital versatile disc (“DVD”) has become the main stream of an optical information storage media due to advantages of high storage density, small volume, long storage period, low cost, high compatibility and low failure rate. However, for storing information containing a large number of texts, sounds and images, the conventional DVD can not meet requirement of next generation. Consequently, several specifications for high density optical storage media of next generation, for example, a high density digital versatile disc (“HD-DVD”) are set forth by some famous optical information storage media manufacturers. In the trend of next generation optical storage media, the wavelength of laser beam is shifted to a range of about 400 nm to about 450 nm of a gallium nitride (“GaN”) laser, and the numerical aperture (“NA”) of an optical pick-up head is enhanced to achieve a high storage density of up to 15 GB of single-side and single-layer of a disc, in order to fit the requirement of high quality audio and video specifications of next generation, for example, a high density television/3 dimensional video (“HDTV/3D-video”). Moreover, several related specifications of storage media and research reports are published.

Because the size of a focusing spot of an optical pick-up head is proportional to resolving power, i.e., proportional to λ/NA, wherein λ is a wavelength of the laser used in the optical pick-up head and NA is a numerical aperture of the object lens. When the NA value of the object lens is enhanced and the wavelength λ of the optical pick-up head is shortened, the size of the focusing spot is minimized. But the spherical aberration due to the variation of the disc thickness and the tilt of the disc correspond to (λ/NA)³ and (λ/NA)⁴ respectively. Therefore the allowed tilt of the disc must be particularly limited. Consequentially, a coverlayer is required to be disposed on a disc in order to increase the allowed tilt of the disc and the focusing length of a laser of a high NA value.

After the disclosure of a specification of optical information storage media for next generation, using an optical pick-up head with two lens combined to have a NA of 0.85 and a coverlayer of 100 nanometer (nm) thickness, is published in 1997 by Sony company, a lot of related research reports are published by some famous optical storage media manufacturers in succession. A specification of a laser pick-up head having a NA of 0.85 has become a trend of development of a optical storage media for next generation.

FIG. 1 is a sectional view illustrating the structure of a reading operation of a disc of a digital video recording system (“DVR system”). First of all, high density data is duplicated on a substrate 100 having a diameter 120 mm and a thickness 1.1 mm by a general injection molding process, and a reflective layer 102 including, but not limited to, aluminum plated layer formed by a sputtering method is provided on the substrate 100. Next, an ultra-thin layer, i.e., a coverlayer 104 with a thickness of 100 nm is formed on the reflective layer 102. Thus, the total thickness of the disc obtained is about 1.2 mm. For reading the information recorded on the disc, a laser beam emitted from the laser pick-up head 106 has to transmit through the coverlayer 104 of a thickness 100 μm to reach the recording layer.

Because the NA of a laser pick-up head is enhanced up to 0.85, and the allowed tilt of a disc is limited by the length of the depth of field. Therefore, if the thickness of a coverlayer is reduced to a specification of an ultra-thin thickness about 100 nm, an optical aberration, especially a coma aberration is easily produced by a small tilt. Furthermore, when the variation of the thickness of a coverlayer is large enough, a spherical aberration is produced due to the destruction of the focusing spot.

In the technical literature published until now, there are two methods for fabricating a coverlayer, in which, one is a spin coating method using a radiation-setting resin material, the other is a thin substrate adhesion method using a Polycarbonate (“PC”) thin substrate.

The coverlayer fabricated by a spin coating method uses a conventional spin coater, wherein a thick layer of radiation-setting resin is spin coated on a substrate and the radiation-setting resin layer hardened by an ultraviolet (“UV”) light. However, the coverlayer fabricated using the conventional coater will have a high variation of the thickness on the edge of a disc when the thickness of the layer is in a range of about 90 nm to about 110 nm. Moreover, because there is a hole in the center of the disc, the conventional spin coating method can not start from the center of the disc, therefore the coverlayer formed by the spin coating method using a conventional spin coater will produce thicker layer near the edge and thinner layer near the center of the disc.

In the thin substrate adhesion method, an ultra-thin PC substrate of 100 nm thickness is formed using an injection molding machine, and then the extra-thin PC substrate is adhered to a substrate of a disc of a thickness about 110 nm by using a radiation-setting resin adhesion method. However, at best, the thickness of the extra-thin PC substrate is only 100 nm due to the technical limitation of a conventional injection molding machine.

### SUMMARY OF THE INVENTION

Accordingly, the present invention is directed to an apparatus for fabricating an ultra thin coverlayer of an optical information storage media suitable for serving as a laser reading operation surface of a high density digital multi-function disc.

The present invention is also directed to an apparatus for fabricating a coverlayer of an optical information storage media, wherein a coverlayer having a uniform average thickness of about 100 nm or less than 100 nm may be obtained.

According to an aspect of the present invention, the above-mentioned apparatus would render the fabrication process for fabricating a coverlayer of an optical information storage media simple and can be automated for mass production. Thus, the yield and the through-put may be effectively promoted.

According to an embodiment of the present invention, the apparatus comprises a rotating platform, a liquid dispenser, a rotating plate positioned opposite to the rotating platform and an ultraviolet (UV) irradiation system. The rotating platform is adopted for supporting a substrate and can be rotated by a shaft connected to an electric motor. The rotating plate is adopted for pressing a radiation setting resin material disposed on the substrate, and can be rotated along with the rotating platform when the rotating platform is rotated by the operation of the electric motor. The UV irradiation system comprises a UV light source for emitting a UV light for irradiating a radiation-setting resin layer formed on the substrate supported on the rotating platform.

The present invention provides a method of operating the apparatus for fabricating a coverlayer. First, a substrate is loaded on the rotating platform. Next, the liquid dispenser is moved to the center of the substrate and a predetermined amount of radiation setting resin material is dispensed on the substrate. Next, the rotating platform is moved upwards towards the rotating plate such that the radiation setting resin material is compressed between the substrate and the rotating plate. Next, the electric motor is turned on to spin the rotating platform such that the rotating platform, the substrate and the rotating plate rotate to spread out the radiation setting resin material to cover the top surface of the substrate under the centrifugal force created by the spinning of the rotating platform and form a thin layer of the radiation setting resin material with a uniform thickness on the substrate. Next, the UV irradiation system is turned on to irradiate the radiation setting resin layer with a UV light so that the radiation setting resin layer hardens and adheres to the top surface of the substrate. Next, the resulting structure is transferred to an automatic film stripping device where the rotating plate is separated from the hardened radiation setting resin layer. Thus, a coverlayer is formed on the substrate.

According to an embodiment of the present invention, the thickness of the radiation setting resin layer formed on the substrate is about 100 nm.

According to an embodiment of the invention, the substrate comprises a high density blue laser optical information storage media including, for example, but not limited to, a disc comprising a read-only memory (ROM) structure, a disc comprising a write-once memory structure or a disc comprising a re-writable (RW) structure. The high density blue laser optical information storage media is related to an optical information storage media, which media is suitable for recording and reproduction operations for a GaN laser or a UV laser disc system using a high NA value larger than 0.5 of an object lens. The GaN laser or UV laser disc system employs a laser with a wavelength less than 460 nm.

According to an embodiment of the present invention, the rotating platform may be moved towards the rotating plate and away from the rotating plate.

According to an embodiment of the present invention, the rotating plate is transparent to UV light. In other words, the rotating plate allows the UV light to pass through.

According to an embodiment of the present invention, a surface of the rotating plate and the rotating platform may have a poor adhesion to a general organic resin material.

It should be noted that the rotating plate has a poor adhesion to general organic resin material or do not adhere to a general organic resin material, and the organic resin material has a better adhesion to the substrate. Therefore, after the organic resin layer is hardened, and the rotating plate can be easily separated from the organic resin layer due to its poor adhesion property.

Furthermore, a poorly-adhesive metal layer can be formed on the rotating plate in order to separate the rotating plate from the organic resin more easily. Furthermore, the rotating plate can be reused.

Because the radiation setting resin layer is sandwiched between the substrate and the rotating plate during the UV irradiation process, the upward stress or downward stress of the radiation setting resin layer may be compensated so that the variation in thickness of the radiation setting resin layer may be minimized, and also the bending of a coverlayer during to a hardening process of radiation setting resin layer by a UV light may also be minimized.

It should be noted that by controlling the compression of the radiation setting resin material on the substrate using the rotating plat and the rotation speed of the rotating platform, a radiation-setting resin layer with a uniform thickness may be obtained, and also it is easy to control the thickness of the radiation setting layer. And, because the apparatus allows a simple process for fabricating the coverlayer, therefore the apparatus can be automated for mass production. Thus, the yield and the through-put can be effectively promoted.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a sectional view illustrating a structure of a reading operation of a disc of a digital video recording system (DVR system).

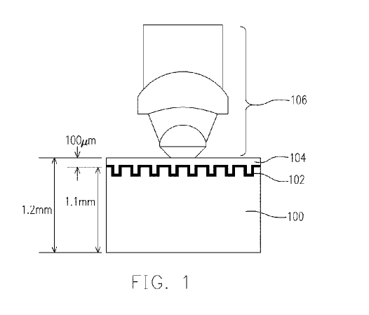

FIG. 2A to FIG. 2D illustrate the steps of fabricating coverlayer of optical information storage media using the apparatus according to a first embodiment of the present invention.

FIG. 3A to FIG. 3D illustrate the steps of fabricating coverlayer of optical information storage media using the apparatus according to a second embodiment of the present invention.

FIG. 4A to FIG. 4D illustrate the steps of fabricating coverlayer of optical information storage media using the apparatus according to a third embodiment of the present invention.

FIG. 5A to FIG. 5D illustrate the steps of fabricating coverlayer of optical information storage media using the apparatus according to a fourth embodiment of the present invention.

FIG. 6A to FIG. 6D illustrate the steps of fabricating coverlayer of optical information storage media using the apparatus according to a fifth embodiment of the present invention.

FIG. 7 is a sectional view illustrating an automatic film stripping device used in the present invention.

FIG. 8 is a sectional view illustrating an apparatus for fabricating the coverlayer of optical information storage media according to an embodiment of the present invention.

FIG. 8A to FIG. 8C illustrate an operation method of the apparatus for fabricating a coverlayer of optical information storage media according to an embodiment of the present invention.

### DESCRIPTION OF THE PREFERRED EMBODIMENTS

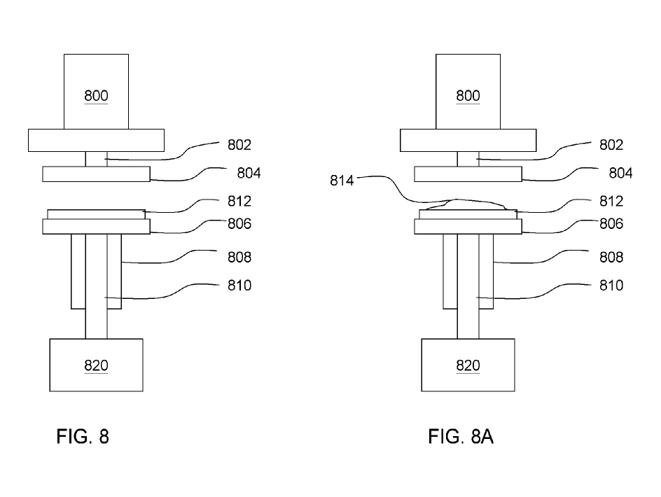

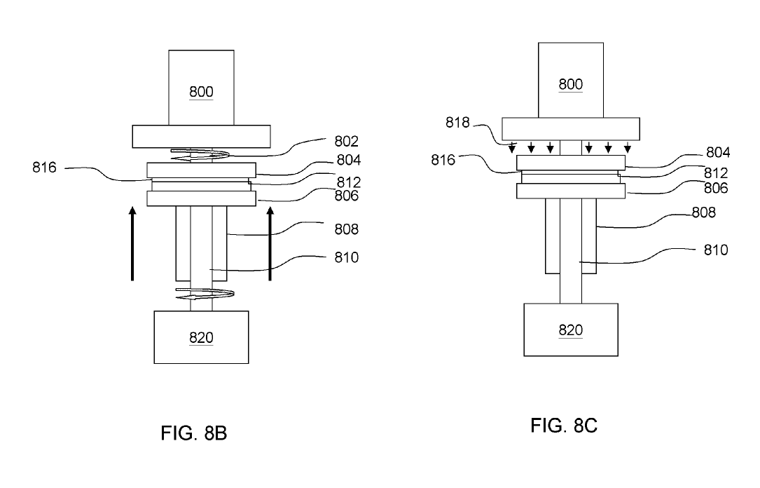

FIG. 8 is a sectional view illustrating an apparatus for fabricating the coverlayer of optical information storage media according to an embodiment of the present invention. As shown in FIG. 8, the apparatus comprises a UV irradiation system 800, a shaft 802, a otating plate 804, a rotating platform 806, a sleeve 808, a shaft 810, an electric motor 820, a vacuum system (not shown) and a liquid dispenser (not shown). The UV irradiation system comprises a UV light source 800 adopted for irradiating the radiation setting resin layer formed on a substrate 812. The rotating plate 804 is adopted for compressing a radiation setting resin material disposed on the substrate 812 to form a radiation setting layer on the substrate 812, and can rotate along with the rotating platform 806. The rotating platform 806 is adopted for supporting a substrate and can be rotated by the shaft 810 connected to the electric motor 820. The rotating platform 806 is a vacuum chuck, wherein a vacuum is applied to the rotating platform 806 for securely holding the substrate 812 during a spin coating process. During the coating process, the bottom of the substrate 812 is disposed on the rotating platform 806 and then a suitable vacuum is then applied to the bottom surface of the substrate 812 such that it stays securely on the rotating platform 806 even at high rotational speed. The rotating motion of the rotating platform 806 is achieved by the shaft 810, which is coaxially positioned in the sleeve 808 and connected to the electric motor 620.

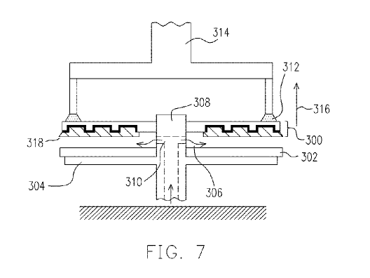

The present invention provides a method of operating the apparatus for fabricating a coverlayer. Referring to FIG. 8A, first, the substrate 812 is loaded on the rotating platform 806. Next, the liquid dispenser is moved to near the center of the substrate 812 and a predetermined amount of a radiation setting resin material 814 is dispensed on the substrate 812. Next, referring to FIG. 8B, the rotating platform 806 is moved upwards towards the rotating plate 804 such that the radiation setting resin material 814 is compressed between the substrate 812 and the rotating plate 804. It should be noted that according to an alternate embodiment of the present invention, the rotating plate 804 may be moved downwards such that the radiation setting resin material 814 is compressed between the substrate 812 and the rotating plate 804. Next, the electric motor 820 is turned on to spin the rotating platform 806 such that the rotating platform 806, the substrate 812 and the rotating plate 804 rotate to spread out the radiation setting material 814 to cover the top surface of the substrate 812 under the centrifugal force created by the spinning of the rotating platform 806 and form a thin radiation setting resin layer 816 with a uniform thickness on the substrate 812. Next, referring to FIG. 8C, the UV irradiation system 800 is turned on to irradiate the radiation setting resin layer 816 with a UV light so that the radiation setting resin layer 816 hardens and adheres to the top surface of the substrate 812. Next, referring to FIG. 7, the resulting structure is transferred to an automatic film stripping device where the rotating plate 804 is separated from the hardened radiation setting resin layer 816. Thus, a coverlayer is formed on the substrate 812.

According to an embodiment of the present invention, the thickness of the radiation setting resin layer 816 is about 100 nm.

According to an embodiment of the invention, the substrate 812 comprises a high density blue laser optical information storage media including, for example, but not limited to, a disc comprising a read-only memory (ROM) structure, a disc comprising a write-once memory structure or a disc comprising a re-writable (RW) structure. The high density blue laser optical information storage media is related to an optical information storage media, which media is suitable for recording and reproduction operations for a GaN laser or a UV laser disc system using a high NA value larger than 0.5 of an object lens. The GaN laser or UV laser disc system employs a laser with a wavelength less than 460 nm.

According to an embodiment of the present invention, the rotating platform 806 may be moved towards the rotating plate 804 and away from the rotating plate 804.

According to an important aspect of the present invention, the rotating plate 804 is transparent to UV light. In other words, the rotating plate 804 allows the UV light to pass through. The surface of the rotating plate 804 is smooth and may have a poor adhesion to a general organic resin material including, but not limited to, acrylic resin, epoxy resin, nitrocellulose, polyvinyl, PMMA, fluoropolymers or silicon. The rotating plate 804 may be comprised of, for example but not limited to plastic or glass material, and is transparent to UV light. The rotating plate 804 in this embodiment comprises pyrex glass.

It should be noted that because the rotating plate 804 has a poor adhesion to general organic resin material or do not adhere to a general organic resin material 814, and the organic resin material 814 has a better adhesion to the substrate, and therefore after the organic resin layer 816 is hardened, and the rotating plate 804 can be easily separated from the organic resin layer 816 due to its poor adhesion property.

Furthermore, a poorly-adhesive metal layer can be formed on the rotating plate 804 in order to separate the rotating plate 804 from the radiation setting resin layer 816 more easily. Furthermore, the rotating plate 804 can be reused.

Because the radiation setting resin layer is sandwiched between the substrate 812 and the rotating plate 804 during the spinning process 818, the upward stress or downward stress of the radiation setting resin layer 816 may be compensated so that the variation in thickness of the radiation setting resin layer 816 may be minimized, and also the bending of the radiation setting resin layer 816 during a hardening process by a UV light may also be minimized.

It should be noted that by controlling the rotating speed of the rotating platform and the compression of the radiation setting material on the substrate using the rotating plate, the thickness of the radiation-setting resin layer may be properly controlled, and also can be of uniform thickness. And, because the apparatus allows a simple process for fabricating the coverlayer, therefore the apparatus can be automated for mass production. Thus, the yield and the through-put can be effectively promoted.

The following embodiment 1 to embodiment 5 describe examples of fabricating the coverlayer of an optical information storage media using the apparatus of the present invention. In the example 1 to example 5, the same elements are referred by the same reference numbers.

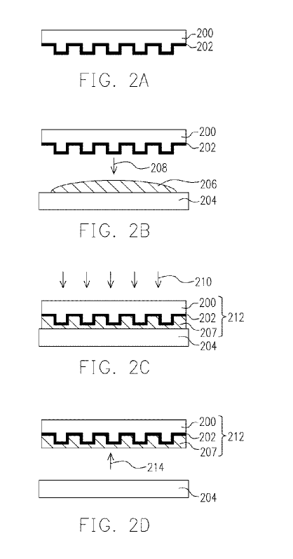

FIG. 2A to FIG. 2D illustrate the fabrication steps of coverlayer of optical information storage media using the apparatus according to the first embodiment of the present invention.

Referring to FIG. 2A, a substrate 200 having digital signal structure or recording layer(s) is disposed on the rotating platform (not shown). The material of the substrate 200 includes, but not limited to, polycarbonate. A reflective layer 202 is formed over the substrate 200, a material of the reflective layer includes, but not limited to, gold, silver, aluminum, copper, chromium and alloy thereof. The method of forming the reflective layer includes, for example, a sputtering method.

Referring to FIG. 2B, a rotating plate 204 with a plain smooth surface is provided, wherein the plate 204 has a poor adhesion or has no adhesion to a general organic resin material including, but not limited to, acrylic resin, epoxy resin, nitrocellulose, polyvinyl, PMMA, fluoropolymers or silicon. The material of the rotating plate 204 includes, for example but not limited to, plastic, glass or metal. In this embodiment, the rotating plate 204 is composed of a pyrex glass. A radiation-setting resin is disposed on the rotating plate 204. The material of the radiation-setting resin includes, but not limited to, acrylic resin, epoxy resin, nitrocellulose, polyvinyl, PMMA, fluoropolymers or silicon. Next, the substrate 200 is moved along the direction of the arrow 208 and the rotating plate 204 is made to come in contact with the radiation-setting resin 206 and the radiation-setting resin 206 is compressed against the surface of the substrate 200 to form a radiation-setting resin layer 207.

Thereafter, referring to FIG. 2C, after the substrate 200 is adhered to the plate 204, the rotating platform is rotated. The thickness of the radiation-setting resin layer 207 can be controlled by controlling the rotating speed of the rotating platform and the compression of the radiation-setting resin material. Next, the radiation-setting resin layer 207 is hardened by illuminating the radiation-setting resin layer 207 using an UV light 210. Thus the hardened radiation-setting resin layer 207 forms a coverlayer of the disc 212.

Finally, referring to FIG. 2D, the disc 212 is separated from the rotating plate 204 by moving the disc 212 along the direction of the arrow 214. The method of separating the disc 212 from the rotating plate 204 includes, but not limited to, a center hole blowing film stripping method. The coverlayer of the disc 212 obtained from the embodiment 1 has an average thickness of about 97±3 nm, in which the average thickness refers to a range from an inner diameter 23 mm to an outer diameter 57 mm of the disc.

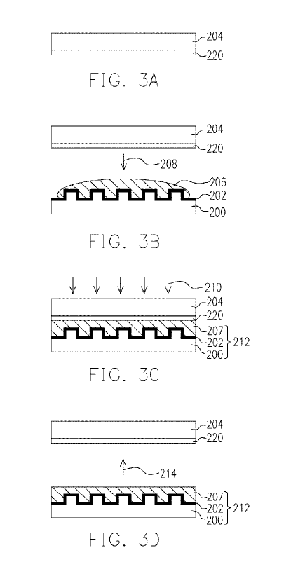

FIG. 3A to FIG. 3D illustrate the fabrication steps of fabricating the coverlayer of optical information storage media using the apparatus according to the second embodiment of the present invention.

Referring to FIG. 3A, a poorly-adhesive metal layer 220 is formed on a rotating plate 204 having a material composed of, but not limited to, polycarbonate (PC) or polymethyl methacrylate (PMMA). The poorly-adhesive metal layer 220 has a poor adhesion, or has no adhesion to a general organic resin material including, but not limited to, acrylic resin, epoxy resin, nitrocellulose, polyvinyl, PMMA, fluoropolymers or silicon. The material of the poorly-adhesive metal layer includes, but not limited to, gold, silver, aluminum, chromium, platinum, nickel, copper, palladium, silicon and the alloy thereof. The method of forming a poorly-adhesive metal layer includes, for example, but not limited to, a sputtering method, and a thickness of the poorly-adhesive metal layer is, for example, about 20 nm.

Referring to FIG. 3B, a substrate 200 having digital signal structure or recording layer(s) is provided, and the material of the substrate includes, but not limited to, polycarbonate. A reflective layer 202 is disopsed over the substrate 200, the plated substrate 200 is placed on a rotating platform (not shown). Then a radiation-setting resin 206 is disposed on the substrate 200. Then, the rotating plate 204 with the poorly-adhesive metal layer 220 is moved along the direction of the arrow 208 and the poorly-adhesive metal layer 220 is made to come in contact with the radiation-setting resin 206 and the radiation-setting resin 206 is compressed against the substrate 200 to form a radiation-setting resin layer 207.

Thereafter, referring to FIG. 3C, after the rotating plate 204 with poorly-adhesive metal layer 220 is adhered to the substrate 200, the rotating platform is rotated. The thickness of the radiation-setting resin layer 206 is controlled by controlling the rotating speed of the rotating platform and the compression. Then, the radiation-setting resin layer 207 is hardened by illuminating the radiation-setting resin layer 207 using an UV light 210. Thus the hardened radiation-setting resin layer 207 forms a coverlayer of the disc 212.

Finally, referring to FIG. 3D, the rotating plate 204 is separated from the disc 212 by moving the plate 204 along the direction of the arrow 214. The method of separating the rotating plate 204 from the disc 212 includes, but not limited to, a center hole blowing film stripping method. The coverlayer of the disc 212 obtained from the method of the second embodiment of the present invention has an average thickness of about 101±3 nm, in which the average thickness refers to a range coverage from an inner diameter 23 mm to an outer diameter 57 mm of the disc. Moreover, the poorly-adhesive metal layer 220 still remains on the rotating plate 204 after the disc 212 is separated from the rotating plate 204, therefore the plate 204 having the poorly-adhesive metal layer 220 can be reused.

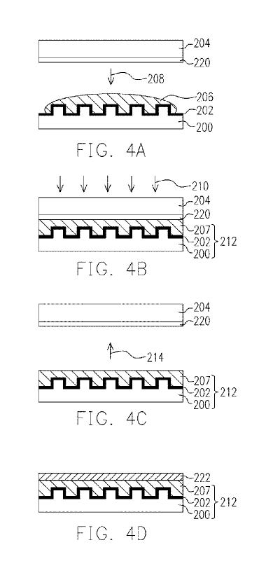

FIG. 4A to FIG. 4D illustrate the fabrication steps of the coverlayer of optical information storage media using the apparatus according to the third embodiment of the present invention.

Referring to FIG. 4A, a poorly-adhesive metal layer 220 is formed on the rotating plate 204 composed of, but not limited to, polycarbonate (PC) or polymethyl methacrylate (PMMA). The poorly-adhesive metal layer 220 has a poor adhesion, or has no adhesion to some organic resin includes, but not limited to, acrylic resin, epoxy resin, nitrocellulose, polyvinyl, PMMA, fluoropolymers or silicon. The material of the poor adhesion metal layer includes, but not limited to, gold, silver, aluminum, chromium, platinum, nickel, copper, palladium, silicon and the alloy thereof. The method of forming the poorly-adhesive metal layer 220 includes, for example, but not limited to, a sputtering method. A thickness of the poorly-adhesive layer 220 is, for example, about 20 nm.

Next, a substrate 200 having a digital signal structure or recording layer(s) is provided. A reflective layer 202 is disposed over the substrate 200, the substrate 200 is placed on the rotating platform (not shown). Then a radiation-setting resin 206 is disposed on the substrate 200. Next, the plate 204 having a poorly-adhesive metal layer 220 is moved along the direction of the arrow 208 and the poorly-adhesive metal layer 220 is made to come in contact with the radiation-setting resin 206 and the radiation-setting resin 206 is compressed against substrate 200 to form a radiation-setting resin layer 207.

Thereafter, referring to FIG. 4B, after the plate 204 having a poorly-adhesive metal layer is adhered to the substrate 200, the rotating platform is rotated. The thickness of the radiation-setting resin layer 207 is controlled by controlling the rotating speed of the rotating platform and the compression. Next, the radiation-setting resin layer 207 is hardened by illuminating the radiation-setting resin layer 207 using an UV light 210. Thus, the hardened radiation-setting resin layer 207 forms a coverlayer of the disc 212.

Finally, referring to FIG. 4C, the rotating plate 204 is separated from the disc 212 by moving the rotating plate 204 along the direction of the arrow 214. The method of separating the plate 204 from the disc 212 includes, but not limited to, a center hole blowing film stripping method. The coverlayer of the disc 212 obtained from this embodiment has an average thickness of about 49±2 nm, in which the average thickness refers to a coverage range from an inner diameter 23 mm to an outer diameter 57 mm of the disc.

Referring to FIG. 4D, by repeating the fabrication steps described above, another coverlayer 222 is formed on the disc 212. The coverlayer 222 of the disc 212 has an average thickness of about 99±3 nm, in which the average thickness refers to a coverage range from an inner diameter 23 mm to an outer diameter 57 mm of the disc. Moreover, the poorly-adhesive metal layer 220 still remains on the plate 204 after the plate 204 is separated from the disc 212, therefore the plate 204 having the poorly-adhesive metal layer 220 can be reused.

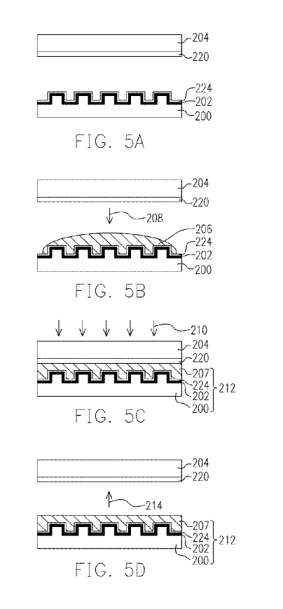

FIG. 5A to FIG. 5D illustrate the fabrication steps of the coverlayer of optical information storage media using the apparatus according to the fourth embodiment of the present invention.

Referring to FIG. 5A, a poorly-adhesive metal layer 220 is formed on the rotating plate 204 composed of a material including, but not limited to, polycarbonate (PC) or polymethyl methacrylate (PMMA). The poorly-adhesive metal layer 220 has a poor adhesion or has no adhesion to the organic resin includes, but not limited to, acrylic resin, epoxy resin, nitrocellulose, polyvinyl, PMMA, fluoropolymers or silicon. The material of the poor adhesion metal layer includes, but not limited to, gold, silver, aluminum, chromium, platinum, nickel, copper, palladium, silicon and the alloy thereof. The thickness of the poorly-adhesive metal layer is, for example, about 10 nm to about 60 nm.

A substrate 200 having a digital signal structure or recording layer(s) is provided. A reflective layer 202 is disposed on the substrate 200. Next, the resulting structure is placed on rotating platform. Next, a radiation-setting resin is spin coated on the reflective layer 202, and the thickness of the radiation-setting resin layer is controlled in a range of, for example but not limited to, 5 μm. Next, the radiation-setting resin layer is hardened by illuminating the radiation-setting resin layer by using an UV light.

Referring to FIG. 5B, a highly adhesive radiation-setting resin 206 is disposed on the substrate 200. Then, the plate 204 having a poorly-adhesive metal layer 220 is moved along the direction of the arrow 208 and the poorly-adhesive metal layer 220 is made to come in contact with the highly adhesive radiation-setting resin 206 and the highly adhesive radiation-setting resin 206 is compressed against substrate 200 to form a radiation-setting resin layer 207.

Thereafter, referring to FIG. 5C, the rotating platform is rotated and the thickness of the radiation-setting resin layer 207 is controlled by controlling the rotating speed of the rotating platform and the compression. Then, the radiation-setting resin layer 207 is hardened by illuminating the radiation-setting resin layer 207 by using an UV light 210. Thus, the hardened radiation-setting resin layer 207 forms a coverlayer of the disc 212.

Finally, referring to FIG. 5D, the plate 204 is separated from the disc 212 by moving the rotating plate 204 along the direction of the arrow 214. The method of separating the rotating plate 204 from the disc 212 includes, but not limited to, a center hole blowing film stripping method. The coverlayer of the disc 212 obtained from using the method of the embodiment 4 has an average thickness of about 97±3 nm, wherein the average thickness refers to a coverage range from an inner diameter 23 mm to an outer diameter 57 mm of the disc. Moreover, the poorly-adhesive metal layer 220 still remain on the plate 204 after the rotating plate 204 is separated from the disc 212, therefore the rotating plate having the poorly-adhesive metal layer 220 can be reused.

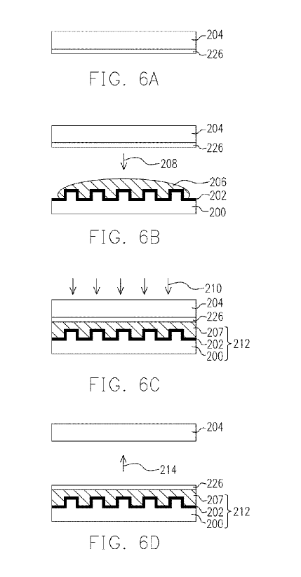

FIG. 6A to FIG. 6D illustrate the fabrication steps of the coverlayer of optical information storage media using the apparatus according to the fifth embodiment of the present invention.

Referring to FIG. 6A, a poorly-adhesive organic material layer 226 is formed on the rotating plate 204 composed of a material including, but not limited to, polycarbonate (PC) or polymethyl methacrylate (PMMA). The poorly-adhesive organic material layer 226 has a poor adhesion to a general organic substrate material including, but not limited to, polycarbonate, polymethyl methacrylate (PMMA), or to a metal material. The material of the poorly-adhesive organic material layer includes, but not limited to, epoxy resin, acrylic resin, polyester, nitrocellulose, polyvinyl resin, polymethyl methacrylate (PMMA), fluoropolymers or silicone rubber. The thickness of the poorly-adhesive organic material layer 226 is, for example, in a range of about 1 μm to about 5 μm.

Referring to FIG. 6B, a substrate 200 having a digital signal structure or record layer(s) is provided. A reflective layer 202 is formed on the substrate 200. The resulting structure is placed on rotating platform (not shown). Next, a highly adhesive radiation-setting resin 206 is disposed on the reflective layer 202. Next, the rotating plate 204 having a poorly-adhesive organic material layer 226 is moved along the direction of the arrow 208 and the poorly-adhesive metal layer 220 is made to come in contact with the radiation-setting resin 206 and the radiation-setting resin 206 is compressed against substrate 200 to form a radiation-setting resin layer 207.

Thereafter, referring to FIG. 6C, after the rotating plate 204 is adhered to the substrate 200, the rotating platform is rotated. The thickness of the radiation-setting resin layer 207 is controlled by controlling the rotating speed of the rotating platform and the compression. Then, the radiation-setting resin layer 207 is hardened by illuminating the radiation-setting resin layer 207 by an UV light 210. Thus, the hardened radiation-setting resin layer 207 forms a coverlayer of the disc 212.

Finally, referring to FIG. 6D, the rotating plate 204 is separated from the disc 212 by moving the rotating plate 204 along the direction of the arrow 214. The method of separating the rotating plate 204 from the disc 212 includes, but not limited to, a center hole blowing film stripping method. The coverlayer of the disc 212 obtained from using the method of the embodiment 5 has an average thickness of about 97±2 nm, wherein the average thickness refers to a coverage range from an inner diameter 23 mm to an outer diameter 57 mm of the disc. Thereafter, the poorly-adhesive organic material layer 226 is provided in order to separate from the rotating plate 204 more easily. Moreover, the poorly-adhesive organic material layer 226 accompanied with the radiation-setting resin layer 206 are separated from the rotating plate 204 after the radiation-setting resin layer 207 is separated from the rotating plate 204.

FIG. 7 illustrates the automatic film stripping device used for separating the rotating plate from the radiation-setting resin layer. The following is a description of the film stripping process. In order to separate the disc 300 from the rotating plate 302, the structure is placed on a vacuum sucking disc base 304 with the central hole of the structure passing through a shaft 308 as shown in FIG. 7. Next, the vacuum sucking disc 330 is allowed to suck the rotating plate 302. The diameter of the rotating plate 302 is a little larger than that of the vacuum sucking disc base 304, and wherein the diameter of the disc 300 is larger than 12 mm. Next, air 306 is blown into the gap between the disc 300 and the rotating plate 302 through a hole 310, which is positioned in the shaft 308. The air 306 is blown from inside of the shaft 308. Next, a vacuum sucking disc 312 of a robotic arm 314 made to come in contact with the disc 300. The vacuum sucking disc 312 of the robotic arm 314 is allowed to suck the disc 300 to hold the disc 300, and the robot arm 314 is made to move along the direction of the arrow 316 to separate the disc 300 from the rotating plate 302. Finally, some redundant residual glue 318 may remain on the edges of the disc 300 can be removed by using a shear or a punch method.

According to an embodiment of the present invention, the automatic film stripping device may be integrated with the apparatus for fabricating the coverlayer of the present invention.

In the description above, the material of the rotating plate is a transparent material, but a non-transparent material may also be used to practice the present invention. If a non-transparent rotating plate is used in the present invention, the UV light used to harden the radiation-setting resin is focussed from the side of the substrate. Moreover, it is to be understood that the thickness of the rotating plate is not a limiting factor. The rotating plate may include a conventional injection molding disc substrate.

According to an aspect of the present invention, because the radiation setting resin layer is sandwiched between the rotating plate and the substrate, the upward stress or downward stress of the radiation-setting resin layer during the spinning process may be effectively compensated. Therefore variation in thickness of the radiation-setting resin layer which would be a case in a conventional spin coating method can be minimized. Furthermore, the bending of the coverlayer due to the hardening of the radiation-setting resin by a UV light can also be minimized.

Furthermore, the use of the rotating plate not only controls the thickness of a radiation-setting resin layer but also forms the radiation-setting resin layer with an excellent uniform thickness. The apparatus of the present invention allows the fabrication of the coverlayer using a simple process, and therefore it can be fully automated for mass production to reduce the overall fabrication cost. Thus, the through-put can also be effectively promoted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An apparatus for fabricating a coverlayer of optical storage media, comprising:
a rotating platform, for holding a substrate;
a rotating plate, positioned opposite to the rotating platform. for compressing a radiation setting resin material disposed on the substrate to form a coverlayer, wherein the rotating plate rotates along with the rotation of the rotating platform; and
an ultraviolet irradiation system, positioned above the rotating plate, for irradiating the coverlayer formed on the substrate.

2. The apparatus for fabricating a coverlayer of optical storage media of claim 1, wherein the rotating plate is transparent to an ultraviolet light.

3. The apparatus for fabricating a coverlayer of optical storage media of claim 1, wherein the rotating plate has poor adhesion or no adhesion to the radiation setting resin material.

4. The apparatus for fabricating a coverlayer of optical storage media of claim 1, wherein the rotating plate comprises a plastic or a glass material.

5. The apparatus for fabricating a coverlayer of optical storage media of claim 1, wherein the rotating plate comprises pyrex glass.

6. The apparatus for fabricating a coverlayer of optical storage media of claim 1, wherein the radiation-setting resin material comprises epoxy, acrylic resin or polyester.

7. The apparatus for fabricating a coverlayer of optical storage media of claim 1, further comprising a vacuum system for holding securely holding the substrate on the rotating platform.

8. The apparatus for fabricating a coverlayer of optical storage media of claim 1, wherein an average thickness of the coverlayer is in a range of about 60 μm to about 150 μm.

9. The apparatus for fabricating a coverlayer of optical storage media of claim 1, wherein the substrate comprises a high density blue laser optical information storage media

10. The apparatus for fabricating a coverlayer of optical storage media of claim 8, wherein the high density blue laser optical information storage media comprises an optical information storage media, wherein the recording and replaying operations for a gallium nitride (“CaN”) laser or an ultraviolet (“UV”) laser disc system using a high NA larger than 0.5 of an object lens.

11. The apparatus for fabricating a coverlayer of optical storage media of claim 10, wherein a wavelength used by the GaN laser or the UV laser disc system is less than 460 nm.

12. The apparatus for fabricating a coverlayer of optical storage media of claim 1, wherein the substrate comprises a disc having a recording layer.

13. The apparatus for fabricating a coverlayer of optical storage media of claim 1, wherein the substrate comprises a disc having a plurality of recording layers.

14. The apparatus for fabricating a coverlayer of optical storage media of claim 1, wherein the substrate comprises a disc having a digital signal structure.

15. The apparatus for fabricating a coverlayer of optical storage media of claim 1, wherein the substrate comprises a disc having a read-only structure.

16. The apparatus for fabricating a coverlayer of optical storage media of claim 1, wherein the substrate comprises a disc having a write-once structure.

17. The apparatus for fabricating a coverlayer of optical storage media of claim 1, wherein the substrate comprises a disc having a re-writable structure.

18. A method of operating an apparatus for fabricating a coverlayer of optical storage media comprising a rotating platform, a rotating plate and an ultraviolet irradiation system, the method comprising:
disposing a substrate on the rotating platform;
disposing a predetermined amount of a radiation setting resin material on the substrate;
compressing the radiation setting resin material by moving the rotating platform towards the rotating plate or by moving the rotating plate towards the rotating platform;
rotating the rotating platform to form a thin radiation setting resin layer between the rotating plate and the substrate;
irradiating the thin radiation setting resin layer using the ultraviolet irradiation system to harden the thin radiation setting resin layer; and
separating the rotating plate from the thin hardened radiation-setting resin layer, wherein the thin hardened radiation setting resin layer remains adhered to the substrate.

19. The method of operating an apparatus for fabricating a coverlayer of optical storage media of claim 1, wherein the rotating plate is transparent to an ultraviolet light, and has poor adhesion or no adhesion to the radiation setting resin material.

20. The method of operating an apparatus for fabricating a coverlayer of optical storage media of claim 1, wherein the rotating plate comprises a plastic or a glass material.
